(19) United States
(12) Patent Application Publication
(10) Pub. No.: US 2001/0033916 A1
(43) Pub. Date: Oct. 25, 2001

(54) Contestant identification for sporting events

(76) Inventors: Vicky L. McCormick, Franktown, CO (US); Joel McCormick, Franktown, CO (US)

Correspondence Address: Richard C. Litman, LITMAN LAW OFFICES, LTD., P.O. Box 15035, Arlington, VA, 22215, US

(21) Appl. No.: 09/789,580

(22) Filed: Feb. 22, 2001

Related U.S. Application Data
(60) Provisional application No. 60/185,393, filed on Feb. 28, 2000.

(51) Int. Cl. B32B 3/00

(52) U.S. Cl. 428/195

(57) ABSTRACT

A contestant identification for attaching to the clothing of competitors in sporting events, with a self-adhesive paper or vinyl number badge having a non-adhesive release liner which is removed from an adhesive front sheet. The adhesive front sheet includes a printed side containing indicia and an adhesive side containing a pressure adhesive. The printed side of the adhesive front sheet includes a outer border portion for a logo or watermark and the inner portion receives a number which identifies the competitor in a sporting event.

### CROSS-REFERENCE TO RELATED APPLICATION

This application claims the benefit of U.S. Provisional Patent Application Ser. No. 60/185,393, filed Feb. 28, 2000.

### BACKGROUND OF THE INVENTION

1. Field of the Invention

The present invention relates to contestant identifications, and more specifically, a contestant identification which is a self-adhesive paper/vinyl number badge fastened to the clothing of a contestant; the identification is particularly useful at horse shows, rodeos, and other sporting events.

2. Description of Related Art

Contestant identification badges that recognize a competitor in sporting event such as horse shows, 4-H clubs, and rodeos are in general use. Currently, safety pins, strings, and elastic arm bands are used to fasten contestant identification badges to the clothing of contestants in sporting events such as horse shows, 4-H clubs, and rodeos, to name just a few sporting events. Safety pins leave holes in expensive athletic clothing which is worn by the competitor in horse show exhibits. One problem with pins is that they fall or slip out and are very easily lost along with the identification. Another problem with safety pins is that they are traditionally used to fasten only the top portion of the identifications and tend to flop around or be torn off in events such as rodeos.

Some English riding competitors use strings to fasten back numbers; the strings are both unattractive and uncomfortable. Dog show owners use elastic arm bands which tend to be too tight or too loose.

An ideal contestant identification badge would include a powerful adhesive that allows the contestant identification to attach to any type of clothing. However, the adhesive would permit easy removal from clothing and not harm or damage the clothing area to which it was attached. The ideal contestant identification would include an outer border region to allow for a sponsor to include a logo or watermark and an inner region for numbers that identify competitors.

The following patents illustrate or describe various types of identification devices.

U.S. Des. Pat. No. 392,583, issued to Sandy L. Hoffman on Mar. 24, 1998, displays an I.D. release badge holder. The badge holder includes two rings held together by a cylindrically shaped member.

U.S. Pat. No. 3,350,799, issued to John J. Japs on Nov. 7, 1967, explains a ticketing structure and procedure. Each ticket has a separable backing sheet and stub portion secured to the sheet by a pressure-sensitive adhesive. When separated, the backing sheet retains the ticket portion and the stub portion may be separated from the ticket portion.

U.S. Pat. No. 4,254,566, issued to Sylvan K. Haskell on Mar. 10, 1981, describes a jogger and runner shoe identification device. The device is an elongated flexible and foldable sheet member having a weakened portion intermediate its length defining a bending line. Two holes are included in the device which each slide onto a shoe lace end.

U.S. Pat. No. 4,619,858, issued to Dam, et al. on Oct. 28, 1986, characterizes an adhesive paper material and a label made from such material. These are self-adhesive paper labels consisting of a thin paper web and a very thin plastic sheet of polyester or a similar material of high tensile strength. Labels are on a co-laminated backing sheet that may be drawn off at high speed, so the production may run at increased speeds.

U.S. Pat. No. 4,726,131, issued to S. Thornton Cass on Feb. 23, 1988, details a tag which includes a primary panel and a secondary panel capable of bearing identification indicia. The secondary panel is detachably secured to the primary panel along a line of separation. A release liner is in contact with an adhesive coated area.

U.S. Pat. No. 5,560,970, issued to Dieter Ludebuhl on Oct. 1, 1996, specifies a display marking tag having an adhesive fastening strip for fastening the tag to the item to be marked. A second strip is adhered to the fastening strip which has a surface for indicia. On the side of the second strip disposed in contact with the fastening strip is a semitransparent coating for decreasing the translucency of the second strip.

U.S. Pat. No. 5,561,932, issued to Frank D. Bracken on Oct. 8, 1996, describes a garment indicia strip and method for size labeling a pair of folded pants. A strip of flexible material has indicia repeatedly printed along a first surface. The indicia has a height no greater than the width of the edge of a folded pair of pants.

U.S. Pat. No. 5,611,160, issued to Nicholas J. Topitzes on Mar. 18, 1997, details stackable ribbons for identification badges and the kit. The badge includes a plastic pocket form name badges with one or more stackable ribbons attached to the badge base. The stackable ribbons are oriented horizontally with a word formed on the power portion of the front face of each ribbon. An adhesive layer is formed on the upper portion of the front face of each ribbon.

U.S. Pat. No. 5,694,651, issued to Paul J. Thomas on Dec. 9, 1997, specifies a method of position color identification for team sports and system. The system is for distinguishing individual team positions to aid in coaching in a multi-player athletic environment including sets of athletic over-vests which utilize different colors to identify selected positions in a pre-selected order. The system also includes a quick change vest for sports with an offense and defense.

U.S. Pat. No. 5,725,713, issued to Jules Fischer on Mar. 10, 1998, characterizes a process for making paper sheets or webs with separable self-adhesive labels.

U.S. Pat. No. 5,776,586, issued to Chris Lipper on Jul. 7, 1998, describes a promotional hang-tag with an integral removable tattoo. The integral tattoo is formed on a multilayer paper backing that is attached to the hang-tag by a pressure sensitive adhesive.

U.S. Pat. No. 5,873,606, issued to Haas, et al. on Feb. 23, 1999, describes a convention badge including a base coat with an adhesive protected by a release liner. The badge assembly includes removing the release liner, placing an identification card in contact with the adhesive, and then attaching a fastener through a slot in the base of the badge.

U.S. Pat. No. 5,902,667, issued to Brett A. Stahl on May 11, 1999, characterizes a method and impressed emblem which includes a cover sheet used together with heat and pressure to impress a desired pattern on an emblem.

None of the above inventions and patents, taken either singly or in combination, is seen to describe the instant invention as claimed.

### SUMMARY OF THE INVENTION

The present invention is a contestant identification badge for attaching to the clothing of competitors in sporting events. The contestant identification includes a self-adhesive paper or vinyl number badge having a non-adhesive release liner which is removed from an adhesive front sheet. The adhesive front sheet includes a printed side containing indicia and an adhesive side containing a pressure-sensitive adhesive. The present invention, thus, provides a contestant identification system overcoming the above-mentioned deficiencies.

Accordingly, it is a principal object of the invention to provide a contestant identification badge which can be utilized without the need for safety pins which tend to leave unattractive holes in competitor's uniform.

It is another object of the invention to provide a contestant identification badge that is removed from the non-adhesive release liner and placed on the clothing of the competitor's back side, with the printed side exposed to viewers and judges.

It is a further object of the invention to provide a contestant identification badge that can be easily removed from the competitor's clothing without damaging or harming the area of clothing to which it was attached.

Still another object of the invention is to provide a contestant identification badge with a pressure-sensitive adhesive side that fastens onto almost any dry surface.

It is an object of the invention to provide improved elements and arrangements thereof a contestant identification in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental view of an example of the contestant identification placed on the back of a horse show competitor of the present invention.

FIG. 2 is an environmental view of another example of the contestant identification placed on the back of a rodeo competitor of the present invention.

FIG. 3 is an environmental, prospective view of the contestant identification according to the present invention.

FIG. 4 is a side view of the contestant identification of the present invention.

Similar reference characters denote corresponding features consistently throughout the attached drawings.

### DETAILED DESCRIPTION OF THE PREFERRED EMBODIMENTS

The present invention is a contestant identification for attaching to the clothing of competitors of a sporting event designated as 10 in the drawings. The contestant identification comprises a self-adhesive paper or vinyl number badge having a non-adhesive release liner which is removed from an adhesive front sheet. The adhesive front sheet includes a printed side containing indicia and an adhesive side containing a pressure-sensitive adhesive.

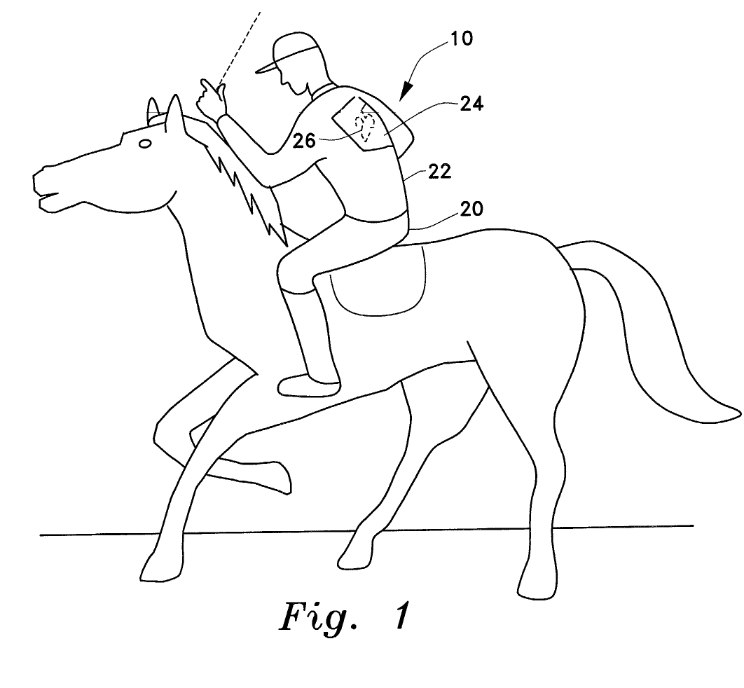

FIG. 1 illustrates an example of the operation of the contestant identification 10 being worn on the clothing 22 of a competitor 20 of a horse show event. During horse show events, competitors 20 are identified by tags which are pinned onto the outer clothing 22 of the competitor's 20 uniform. The safety pins used tend to leave unattractive holes in a competitor's 20 uniform.

The present invention 10 includes a self-adhesive contestant identification badge which can be utilized without the need for safety pins. The adhesive front sheet 24 of the identification badge is removed from the non-adhesive release liner (not shown) and placed on the clothing 22 of the competitor's 20 back side with the printed side 26 exposed to viewers and judges. When the competitor 20 has finished competing in the event, the adhesive front sheet 24 can be easily removed without damaging or harming the area of clothing 22 to which it was attached.

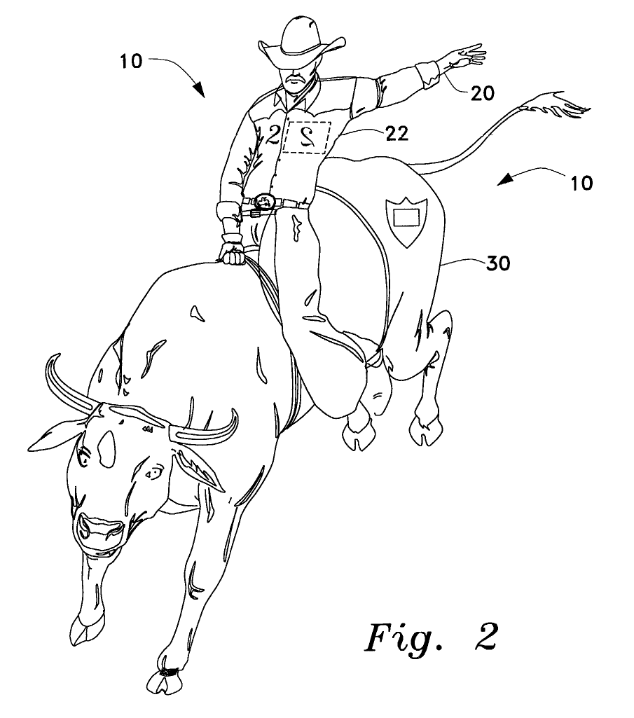

FIG. 2 displays another example of the operation of the contestant identification 10 being worn on the clothing 22 of a competitor 20 of a rodeo event. In rodeo events, the competitors usually are identified by several tags. These tags are typically pinned, stringed, or held on by elastic arm or leg bands. The pinned and stringed varieties are attached the top portion of the tag to different areas on the competitor's clothing 22.

Tags attached only by the top portion tend to flop around due to the nature of the sporting event. For example, a rider 20 competing in a bronco bull riding event causes the competitor 20 to be jolted in all directions thereby having the bottom portion of the tags fly upwards and conceal the number that identifies the competitor 20.

Identification tags which are attached to the competitor's clothing 22 in rodeo events are known to be secured to the competitors 20 chest and/or back side, legs, arms, and even to the animal's saddle or body 30. The advantage of using a contestant identification badge with a pressure-sensitive adhesive side (not shown) is that it will fasten onto almost any dry surface.

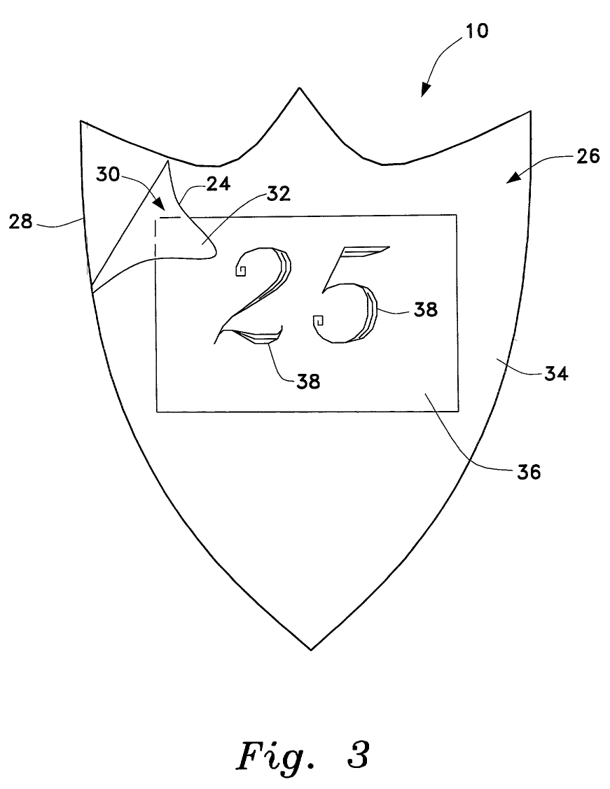

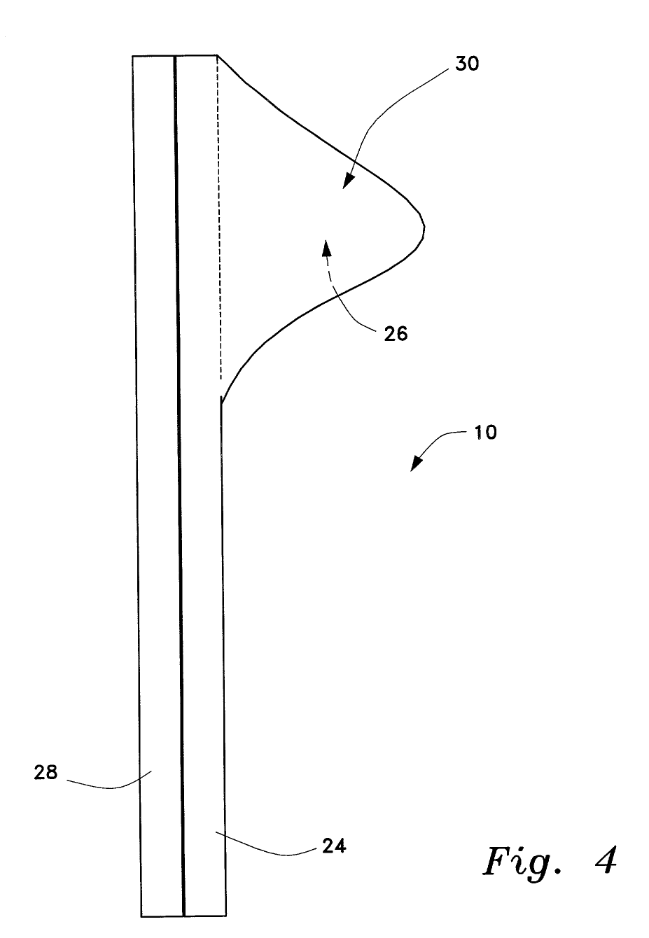

FIG. 3 and FIG. 4 shows the construction of the contestant identification badge 10 used in sporting events. The contestant identification 10 comprises a self-adhesive paper or vinyl number badge having a non-adhesive release liner 28 which is removed from an adhesive front sheet 24. The adhesive front sheet 24 includes a printed side 26 containing indicia and an adhesive side 30 containing a pressure-sensitive adhesive.

The non-adhesive release liner 28 acts as a protective paper and is attached to the adhesive side 30 of the front sheet 24. Such protective paper 28 is well known in the art and is widely used a release paper to protect the coating on the pressure-sensitive adhesive side 30 of the front sheet 24. Preferable, the non-adhesive release liner 28 comprises a material that can be easily releasable from the adhesive side 30 of the adhesive front sheet 24.

One edge of each of the contestant identification badges 10 may include an unsecured edge 32. The unsecured edge 32 will tend to curl and make a natural finger-grip portion for removal of the non-adhesive release liner 28. In one example 10, the printed side 26 of the adhesive front sheet 24 of the contestant identification badge 10 may include an outer border portion 34 and an inner portion 36. The outer border portion 34 is dimensioned and configured to receive indicia such as a sport event/team logo, symbols, or watermark (not shown). The inner portion 36 is dimensioned and configured to receive a number 38 that is issued to the competitor for the sporting event in which they are competing.

The indica 38 on both the outer border portion 34 and the inner portion 36 of the printed side 36 of the adhesive front sheet 24 may be manufactured with indica 38 already stamped on the printed side 36. In another example of the contestant identification badge 10, the inner portion 36 can be manufactured without indicia 38 printed on the inner portion 36. Thus, the number 38 can be marked on the inner portion 36 of the printed side 26 with a writing instrument. It may be necessary to have the inner portion 36 manufactured without any indicia because numbers 38 issued to competitors for identification purposes sometimes change during sporting events.

It is to be understood that the present invention is not limited to the embodiments described above, but encompasses any and all embodiments within the scope of the following claims.

We claim:

1. A contestant identification badge for recognizing competitors in sporting events, comprising:
a self-adhesive badge having a non-adhesive release liner and a adhesive front sheet, said non adhesive release liner removably attached to said adhesive front sheet by a fastening means, said adhesive front sheet having a printed side and an adhesive side.

2. The contestant identification badge according to claim 1, wherein said printed side of said adhesive front sheet further comprises an outer border portion that is dimensioned and configured to receive indicia to identify the sporting event.

3. The contestant identification badge according to claim 1, wherein said printed side of said adhesive front sheet further comprises an inner portion that is dimensioned and configured to receive indicia such as a number to identify a competitor in the sporting event.

4. The contestant identification badge according to claim 1, wherein said fastening means for removably attaching said non-adhesive release liner to said adhesive front sheet is the pressure-sensitive adhesive on said adhesive side of said adhesive front sheet.

5. The contestant identification badge according to claim 1, wherein said non-adhesive release liner comprises a material easily releasable from said adhesive side of said adhesive front sheet.

6. The contestant identification badge according to claim 1, wherein said adhesive side of said adhesive front sheet includes a pressure-sensitive adhesive.

7. The contestant identification badge according to claim 1, wherein said self-adhesive badge is made of paper.

8. The contestant identification badge according to claim 1, wherein said self-adhesive badge is made of vinyl.
